(19) United States
(12) Patent Application Publication
(10) Pub. No.: US 2010/0213429 A1
(43) Pub. Date: Aug. 26, 2010

(54) JACK ASSEMBLY WITH MULTIPLE DEGREES OF FREEDOM

(76) Inventors: Frank Drake, Wausau, WI (US); Michael Murphy, Wausau, WI (US)

Correspondence Address: MCDONALD HOPKINS LLC, 600 Superior Avenue, East, Suite 2100, CLEVELAND, OH, 44114-2653, US

(21) Appl. No.: 12/709,779

(22) Filed: Feb. 22, 2010

Related U.S. Application Data
(60) Provisional application No. 61/208,166, filed on Feb. 20, 2009.

(51) Int. Cl. B60S 9/02; B60S 9/04; B66F 7/26

(52) U.S. Cl. 254/89 R

(57) ABSTRACT

A jack assembly having multiple degrees of freedom is described. The jack assembly may provide the user the ability to select single degrees of freedom as desired. The jack assembly may include a pair of jacks, a connecting rod assembly, and a pivot adapter. The jacks may be engaged with a trailer and are adjustable along a Z-axis. The jacks may include an outer tube in a telescopic relationship with an inner tube and a drop leg in a telescopic relationship with the inner tube. The connecting rod assembly may be located between the jacks and be adjustable along an X-axis. The pivot adapter may be capable of pivoting the jacks in a Y-Z plane. The adapter may include a first end secured to an end of the connecting rod assembly and a second end secured to one of the jacks.

### CROSS-REFERENCE TO RELATED APPLICATION

This application claims benefit from U.S. Provisional Patent Application No. 61/208,166, entitled “Jack Assembly With Multiple Degrees of Freedom,” filed on Feb. 20, 2009, which is hereby incorporated by reference in its entirety.

### FIELD OF INVENTION

The present invention relates generally to jack assemblies and, more particularly, to jack assemblies having multiple degrees of freedom of movement.

### BACKGROUND

Towed vehicles or trailers are often designed to secure and haul cargo. The trailers may be towed being a towing vehicle, such as a truck or SUV. Trailers may be arranged to haul specific types of cargo such as boats, automobiles, consumer products, and the like. Jacks and jack assemblies have long been used with towing trailers, whereby the trailers may be supported by a trailer jack. Such trailer jack assemblies may support the trailer in a horizontal position when the trailer is uncoupled from a towing vehicle.

Typically, a jack assembly may be secured to the towing trailer, such as to a trailer tongue. The jack assembly may assist in stabilizing the towing trailer while the trailer may be detached from the towing vehicle. The jack assembly may be utilized to maintain or support the towing trailer in a level position when the trailer is disengaged from the towing vehicle by elevating one end of the trailer off the ground. In addition, a jack assembly may often be used to assist in engaging the towing trailer with the towing vehicle or disengaging the towing trailer from the towing vehicle. A jack assembly may also be utilized to change the vertical position or height of the tongue of a trailer as the tongue is mounted onto or dismounted from the hitch of a towing vehicle.

Normal jacks may incorporate a single degree of freedom, whereby the jack may be allowed to adjust in a single direction, such as a vertical adjustment. However, in some circumstances it may be advantageous to incorporate additional degrees of freedom to allow for greater functionality of the jack assembly. For example, a jack assembly may be pivotally mounted to a trailer, such as on a trailer tongue, so as to be pivotal between a vertical position and a horizontal position. In the vertical position, the jack may be vertically adjustable to lift and lower the trailer. The horizontal position often allows the jack assembly to be stowed when the jack assembly is not in use.

In some circumstances, an additional degree of freedom may be desired to align a jack assembly with a trailer or vehicle. For example, a jack assembly may include two jacks interconnected by a connecting bar. It may be advantageous to increase the distance between the jacks to adapt the jack assembly to a trailer or vehicle with a wide wheelbase. It may also be advantageous to decrease the distance between the jacks to adapt the jack assembly to a trailer or vehicle with a narrow wheelbase.

### SUMMARY

A jack assembly having multiple degrees of freedom is described. The jack assembly may provide the user the ability to select single degrees of freedom as desired. The jack assembly may include a pair of jacks, a connecting rod assembly, and a pivot adapter. The jacks may be engaged with a trailer and are adjustable along a Z-axis. The jacks may include an outer tube in a telescopic relationship with an inner tube and a drop leg in a telescopic relationship with the inner tube. The connecting rod assembly may be located between the jacks and be adjustable along an X-axis. The pivot adapter may be capable of pivoting the jacks in a Y-Z plane. The adapter may include a first end secured to an end of the connecting rod assembly and a second end secured to one of the jacks.

### BRIEF DESCRIPTION OF THE DRAWINGS

Objects and advantages together with the operation of the invention may be better understood by reference to the detailed description taken in connection with the following illustrations, wherein:

FIG. 1 illustrates a perspective view of a retracted jack assembly.

FIG. 2 illustrates a perspective view of an extended jack assembly.

FIG. 3 illustrates a front view of the retracted jack assembly of FIG. 1.

FIG. 4 illustrates a side view of the retracted jack assembly of FIG. 1.

FIG. 5 illustrates a top view of the retracted jack assembly of FIG. 1.

FIG. 6 illustrates a perspective view of a retracted jack assembly.

FIG. 7 illustrates a close up perspective view of a pivot adapter of the jack assembly.

FIG. 8 illustrates a front view of the extended jack assembly of FIG. 2.

FIG. 9 illustrates a side view of the extended jack assembly of FIG. 2.

FIG. 10 illustrates a bottom view of the extended jack assembly of FIG. 2.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

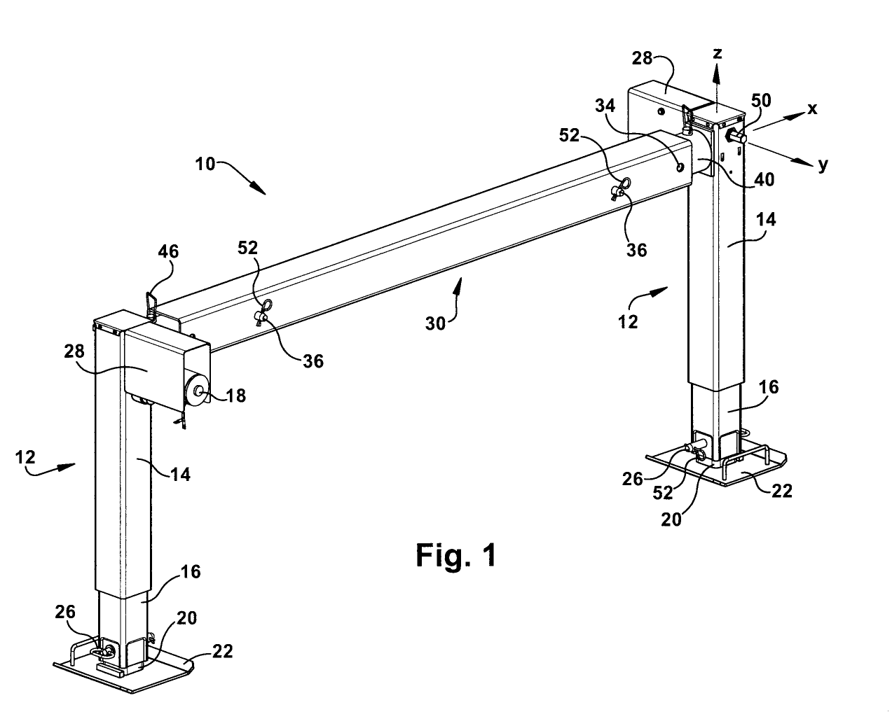

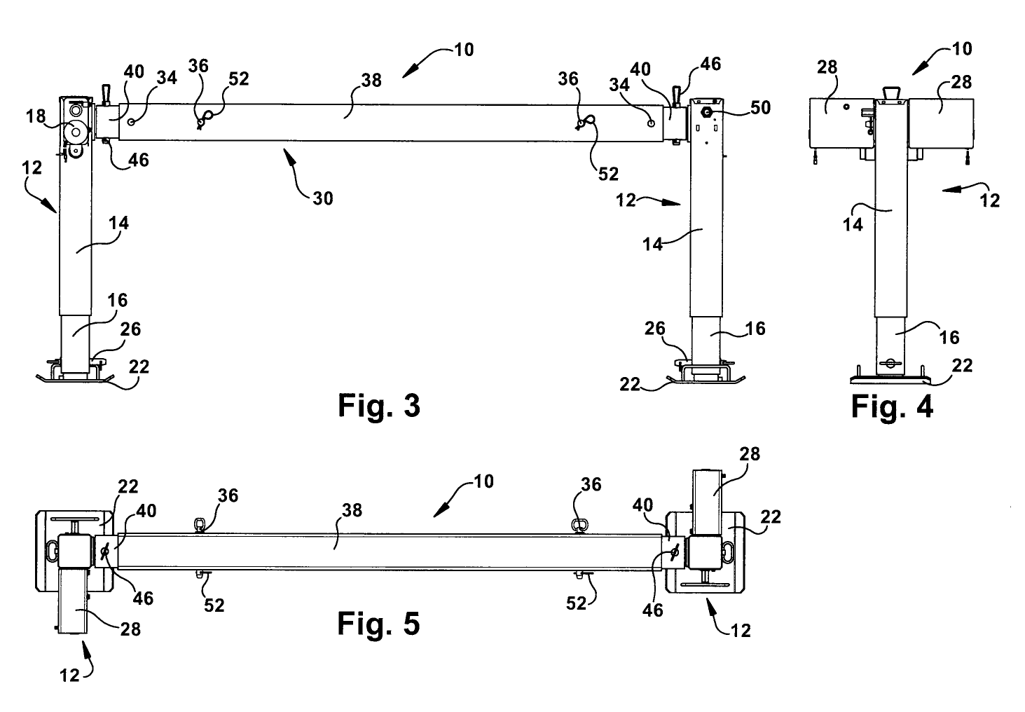

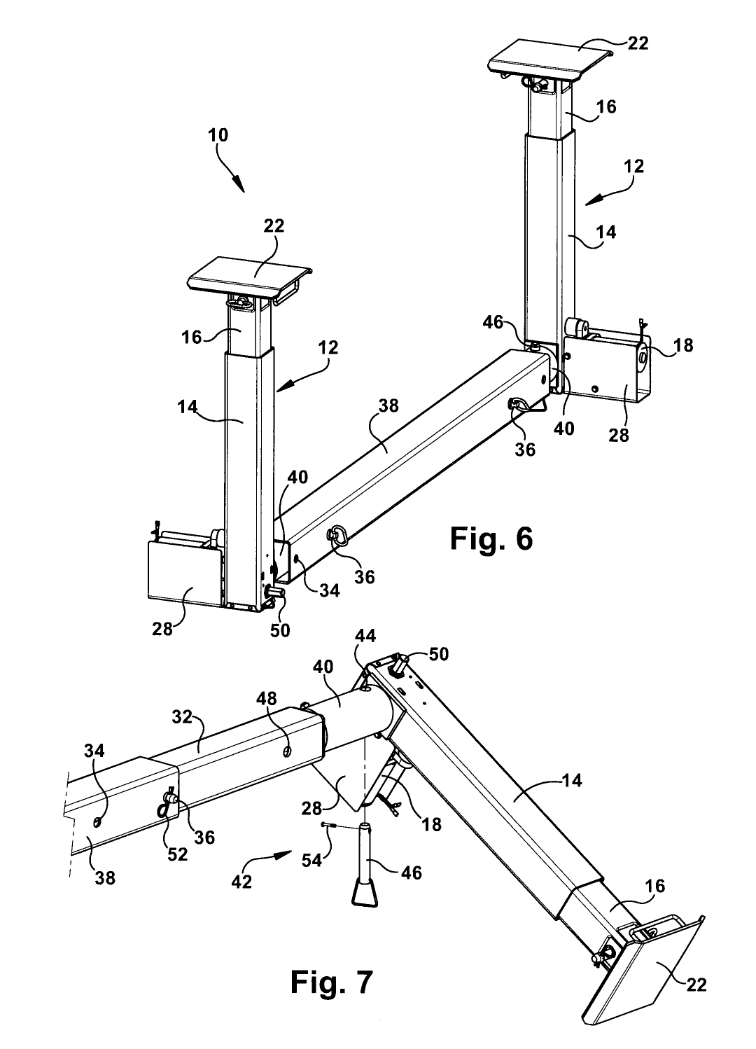

A jack assembly 10 having multiple degrees of freedom is illustrated in FIGS. 1-10. The jack assembly 10 may include at least one jack 12. The jack assembly 10 may utilize any appropriate number of jacks. For example, the jack assembly 10 may include a pair of jacks 12. The jacks 12 may be configured to be vertically adjustable. The jacks 12 may be of any appropriate shape, size or type.

The jacks 12 may include an outer tube 14 and an inner tube 16 (FIGS. 1-4 and 6-9). The outer tube 14 may be of any appropriate shape or size, such as a generally rectangular or cylindrical shape. The inner tube 16 may be of any appropriate shape or size, such as a generally rectangular or cylindrical shape. For example, the inner tube 16 may be of a correspondingly similar shape as the outer tube 14. In addition, the inner tube 16 may be of a slightly smaller size than that of the outer tube 14, whereby the inner tube 16 may fit within the outer tube 14.

The outer tube 14 may be telescopically engaged with the inner tube 16. Generally, telescopic movement of the outer tube 14 relative to the inner tube 16 may allow for adjustment of the overall height of the jack assembly 10 along a Z-axis (FIGS. 1-4 and 6-9). Typically, a user of the jack assembly 10 may want to alter the height of the jack assembly 10 to support a trailer in a level position. A user may also want to adjust the height of the jack assembly 10 to facilitate the mounting and dismounting of a trailer or towed vehicle to a towing vehicle.

To facilitate relative movement of the outer tube 14 and the inner tube 16, at least one bushing (not shown) may be positioned between the outer tube 14 and the inner tube 16. The bushing may be of any appropriated shape, size or type. For example, an outer tube bushing (not shown) may be secured to a lower end of the outer tube 14 such that a portion of the bushing may be positioned between the outer tube 14 and the inner tube 16 to prevent direct contact between the outer tube 14 and the inner tube 16. An inner tube bushing (not shown) may also be secured to an upper end of the outer tube 14 such that a portion of the bushing may be positioned between the outer tube 14 and the inner tube 16 to prevent direct contact between the outer tube 14 and the inner tube 16. It is to be understood that a bushing may be secured to an upper end of the outer tube 14 or secured to a lower end of the inner tube 16 to prevent direct contact of the outer tube 14 and the inner tube 16.

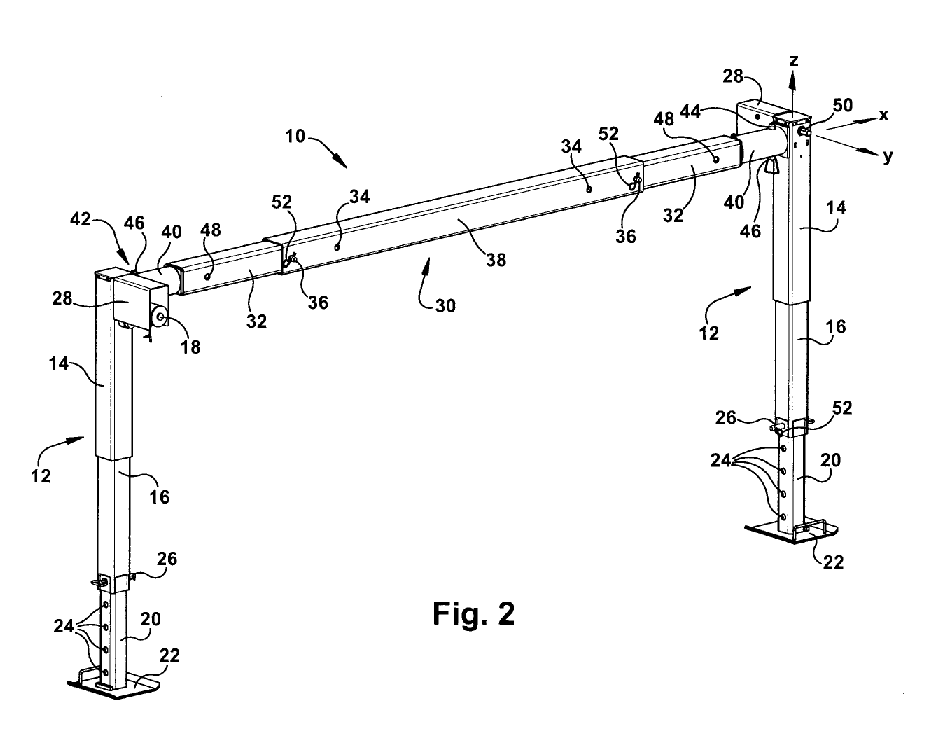

Each jack 12 may also include a drop leg 20 or “through the air” leg (FIGS. 1-10). The drop leg 20 may be of any appropriate shape or size, such as a generally rectangular or cylindrical shape. For example, the drop leg 20 may be of a similar shape to that of the inner tube 16. In addition, the drop leg 20 may be of a slightly smaller size than that of the inner tube 16, whereby the drop leg 20 may fit within the inner tube 16. The drop leg 20 may be selectively fixed to the inner tube 16 at a desired position. The drop leg 20 may include a plurality of apertures 24 (FIGS. 2 and 9).

The inner tube 16 may also include at least one aperture (not shown). For example, the inner tube 16 may include apertures located on each and opposite sides of the inner tube 16. The apertures may be of any appropriate shape or size, such as a generally circular, square or rectangular shape. The apertures may be located at any appropriate position on the inner tube 16, such as generally in an aligned relationship with one another, whereby a fastener 26, such as a pin) may be located through both the apertures within the inner tube 16.

The apertures 24 of the drop leg 20 may be of any appropriate shape or size, such as a generally circular, rectangular or square shape. The apertures 24 may be located at any appropriate position on the drop leg 20, such as on each side of the drop leg 20 and in a linear arrangement along a vertical side of the drop leg 20 (FIGS. 2 and 9). The drop leg 20 may also utilize a fastener 26, such as a pin, bolt, and the like (FIGS. 1 and 2). The pin 26 may be of any appropriate shape or size. The pin 26 may be inserted through the apertures of the inner tube 16 and also inserted through the apertures 24 to lock the drop leg 20 in place at the desired height. An additional fastener 52, such as a cotter pin, may also be utilized to secure the pin 26 within the apertures to maintain the desired height of the drop leg 20.

The drop leg 20 may be used to quickly extend or lower the jack assembly 10 along a Z-axis to the floor or ground. For example, the drop leg 20 may be in a sliding, telescopic relationship with inner tube 16 (FIGS. 2, 8 and 9). When the jack assembly 10 is raised above a surface such as the ground, the drop leg 20 may be released to quickly extend a distance from the inner tube 16. When released, the drop leg 20 may come into immediate contact with the floor or ground or may go a certain distance towards the ground, whereby the jack 12 may need additional extension, such as via the inner leg 16 and outer leg 14 to reach the floor or ground.

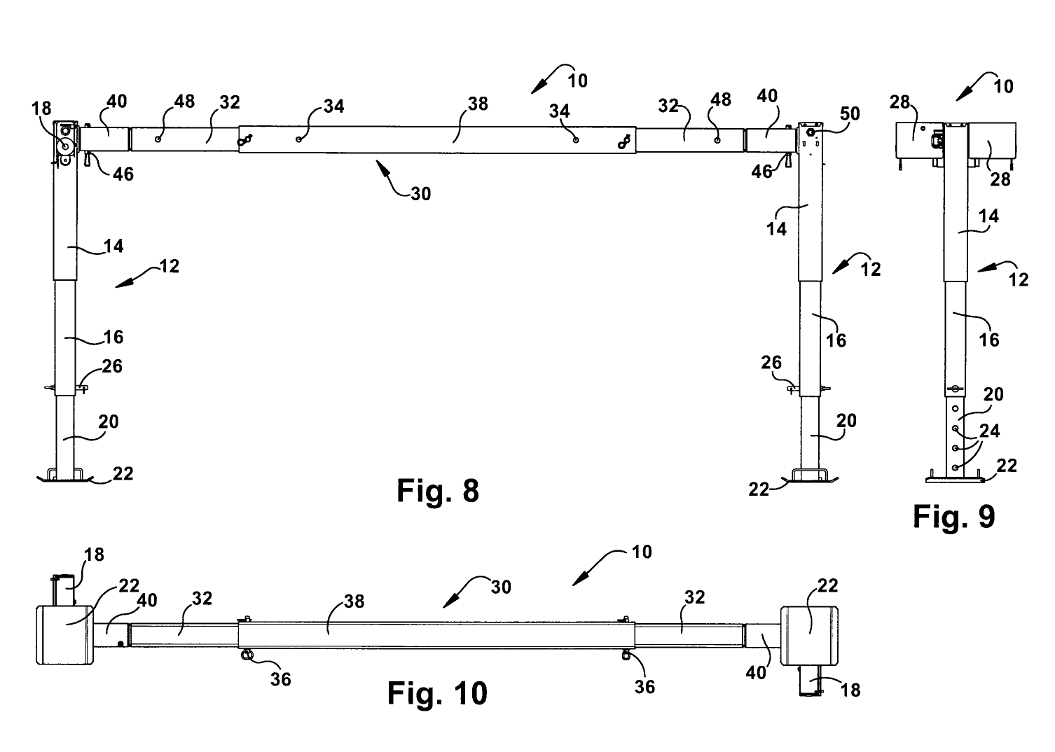

Each jack 12 may include a jack base 22 (FIGS. 1-10). The jack base 22 may be connected to an end of the drop leg 20 to engage the ground or surface, thereby supporting the outer tube 14, inner tube 16 and drop leg 20 of the jack 12 (FIGS. 2 and 8). The jack base 22 may be connected to the drop leg 20 by any appropriate means, such as by fasteners, welding or the like. The jack base 22 may be of any appropriate shape or size, such as a generally square, circular, triangular or rectangular shape. The jack base 22 may be of a generally larger size than the end of the drop leg 20, whereby the jack base 22 may provide a stable surface for the jack 12 to rest on.

The jack assembly 10 may also include a connecting bar assembly 30 (FIGS. 1 and 2). The two jacks 12 may be interconnected by the connecting bar assembly 30. The connecting bar assembly 30 may be adjustable to vary the distance between the jacks 12. The connecting bar assembly 30 may be of any appropriate shape or size. The connecting bar assembly 30 may include at least one adjustable section 32 and a central section 38. For example, the connecting bar assembly 30 may include a pair of adjustable sections 32.

The adjustable sections 32 may be of any appropriate shape or size, such as a generally square or cylindrical shape. The central section 38 may be of any appropriate shape or size, such as a generally square or cylindrical shape. For example, the adjustable sections 32 and the central section 38 may be of correspondingly similar shapes. The adjustable sections 32 may be of a slightly smaller size than that of the central section 38, whereby the adjustable sections 32 may fit within the central section 38 (FIGS. 2, 7 and 8). The adjustable sections 32 may be located at any appropriate position on the jack assembly 10, such as being located adjacent the central section 38. For example, the adjustable sections 32 may be located on either side of the central section 38 (FIGS. 2 and 8).

Each adjustable section 32 may telescopically engage the adjacent adjustable section 32. Each adjustable section 32 may also telescopically engage the central section 38. The central section 38 may include one or more apertures 34. The apertures 34 may be of any appropriate shape or size, such as a generally circular or square shape. The apertures 34 may be located at any appropriate position on the central section 38. For example, the apertures 34 may be located on either side of the central section 38, whereby the apertures 34 may be aligned on each side of the central section 38 to allow for a fastener to be located there through.

The adjustable sections 32 may include one or more apertures 48 (FIGS. 2, 7 and 8). The apertures 48 may be of any appropriate shape or size, such as a generally circular or square shape. The apertures 48 may be located at any appropriate position on the adjustable section 32. For example, the apertures 48 may be located on either side of the adjustable section 32, whereby the apertures 48 may be aligned on each side of the adjustable section 32 to allow for a fastener to be located there through.

The apertures 48 may selectively secure the adjustable sections 32 in place. A fastener 36, such a pin, bolt or the like may be utilized. For example, a pin 36 may be inserted through the aligned apertures 48 of two adjustable sections 32 to fix the adjustable sections 32 at the desired location (FIGS. 2, 7, 8 and 10). An additional fastener 52, such as a cotter pin, may also be utilized to secure the pin 36 within the aperture to maintain the desired length of the adjustable sections 32 (FIGS. 2 and 7). The connecting bar assembly 30 may include any number of adjustable sections 32.

The first adjustable section 32 may be telescopically connected to a first end of the central portion 38. The second adjustable section 32 may be telescopically connected to a second end of the central portion 38 opposite that of the first end. The central portion 38 and adjustable sections 32 may include a plurality of linearly aligned apertures 34, 48 respectively (FIGS. 2, 7 and 8). The connecting bar assembly 30 may be fixed at any desired length along an X-axis by aligning the apertures 34 in the central portion 38 with the apertures 48 in the adjustable sections 32 that correspond to the desired length. The pin 36 may then be inserted through the desired apertures 34, 48 (FIGS. 1-3, 5-8 and 10). An additional fastener 52, such as a cotter pin, may also be utilized to secure the pin 36 within the apertures 34, 48 to maintain the desired length of the connecting bar assembly 30 (FIGS. 1-3).

The jack assembly 10 may further include an additional degree of freedom. For example, the jacks 12 may be rotatable about the connecting bar assembly 30 between a vertical position and a horizontal storage position (i.e., rotating in the Y-Z plane about the X-axis). To facilitate rotation, the jack assembly 10 may include at least one pivot or rotational adapter 40 (FIGS. 1-3, 5-8 and 10). For example, the jack assembly 10 may include a pair of adapters 40.

The adapters 40 may be of any appropriate shape, size, type or configuration. For example, the adapters 40 may be of a generally cylindrical or tubular member. The pivot adapters 40 may be located at any appropriate position on the jack assembly 10, such as at each end of the connecting bar assembly 30. For example, the adapters 40 may also be located between an end of the adjustable section 32 and the outer tube 14 of the jack 12. The adapters 40 may be located adjacent the jacks 12, whereby the adapters 40 may each be pivotally connected to a jack 12. The adapter 40 may be configured to allow the jack 12 to pivot with respect to the connecting bar assembly 30 and vice versa (FIG. 7), such as in the Y-Z plane.

The adapters 40 may be connected to the connecting bar assembly 30 or the adjustable sections 32 by any appropriate means, such as by fasteners, welding or the like. The adapters 40 may be connected to the jacks 12 or the outer tubes 14 by any appropriate means, such as by fasteners, welding or the like. The adapters 40 may be configured to receive a rotational portion (not shown) of the jack 12 and allow the rotational portion to pivot therein. The adapters 40 may further include any appropriate means for preventing rotation of the jacks 12, such as with fasteners or the like. For example, a pin assembly 42 may be utilized to prevent rotation of the jacks 12 (FIG. 7).

The pin assembly 42 may include at least one fastener, such as a pin 46 and a bolt 54 (FIG. 7). The fasteners may be of any appropriate shape, size or type. The bolt may be utilized to secure the pin 46 in place within the adapter 40 and the rotational portion of the jack 12. The adapter 40 may include at least one aperture 44. For example, the adapter 40 may include a pair of apertures 44. The rotational portion may also include at least one aperture (not shown). For example, the rotational portion may include a pair of apertures. The apertures 44 may be of any appropriate shape or size, such as generally circular or square. The apertures 44 of the adapter 40 and the apertures of the rotational portion may be of a generally similar shape and size and may also be aligned with one another.

The apertures 44 may be located at any appropriate position on the adapter 40, such as on opposite sides of the adapter 40. The apertures 44 of the adapter 40 and the rotational portion may each receive the pin 46 there through. When the pin 46 is inserted through the aligned apertures 44, the rotational portion may be prevented from pivoting with respect to the adapter 40. The jack assembly 10 may further include any appropriate means for preventing adjustment of the connecting bar assembly 30 while the pin 46 may be removed from the apertures 44.

The height of the jack assembly 10 may be increased or decreased either manually or automatically. For example, each jack 12 may include internal gears (not shown) for raising and lowering the jack 12 mechanically in response to manually turning a hand crank or a handle (not shown). A description of a jack system that utilizes internal mechanical gears and a hand crank is set forth in U.S. Pat. No. 6,893,006, which is herein incorporated by reference.

As an alternative, the height of the jack assembly 10 may be increased or decreased with at least one motor 18. The motor 18 may be of any appropriate shape, size or type. For example, the motor 18 may be an electric motor, connected to a power source such as a battery (not shown). A description of a motor powered jack system is set forth in U.S. Publication No. 2007/0210289, which is herein incorporated by reference.

Each jack 12 may include a motor 18 for adjusting the height of the jack assembly 10, whereby the jack assembly 10 may include a pair of motors 18 (FIGS. 1 and 2). The motor 18 may be located at any appropriate position on the jack assembly 10, such as being located towards an end of the jack 12 opposite that of the jack base 22. The motor 18 may include a gear box (not shown). The gearbox of the motor 18 may be coupled to and aligned with a drive shaft 50 of the jack 12.

The drive shaft 50 may be of any appropriate shape, size or type, such as a generally cylindrical shape that may also include faceted sides. The drive shaft 50 may be integrally formed with the gear box of the motor 18 (FIGS. 1 and 2). Horizontal rotation of the drive shaft 50 may be translated into vertical movement of the inner jack tube 16.

The jack assembly 10 may also include at least one guard plate or cover 28 for the motor 18 (FIGS. 1, 2, 4, 6, 7 and 9). For example, there may be a cover 28 for each motor 18, such as a pair of covers 28. The covers 28 may be of any appropriate shape or size, such as a generally open ended rectangular or square shape. The covers 28 may be secured to the jack 12 and/or motor 18 by any appropriate means, such as by welding, fasteners or the like. The covers 28 may be located at any appropriate position on the jack assembly 10 such as adjacent to the top of the jack 12 and substantially encasing the motor 18. The cover 28 may protect the motor 18 during use.

While the jack assembly 10 has been described as having either mechanical or motorized adjustability, it will be appreciated that the jack assembly 10 may incorporate both mechanical and motorized adjustability. The jack assembly 10 may further incorporate any appropriate means of adjustability known in the art, such as hydraulics, pneumatics, and the like.

Typical jacks may include one degree of freedom, such as a vertical or height adjustment along a Z-axis. The jack assembly 10 may include an anti-rotation feature, such as a pin assembly 42 (FIG. 7). Once the pin 46 is removed, the jack assembly 10 may also incorporate rotation about an X-axis, such as between the Y-Z plane. The anti-rotation feature may also prevent the jack 12 from extending lengthwise or horizontally along the X-axis, whereby the jack 12 may come off or become loose from it's pivot adapter 40 mount. The jack assembly 10 may provide for a practical method to swing or rotate the jack 12 up for faster and greater clearance with a controlled action as selected by the user.

In addition, the overall length of the jack assembly 10 may be adjusted horizontally or along a X-axis. The connecting bar assembly 30 may be fixed at any desired length along an X-axis by aligning the apertures 34 in the central portion 38 with the apertures 48 in the adjustable sections 32 that correspond to the desired length.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. A jack assembly for raising or lowering a trailer, said jack assembly comprising:
a pair of jacks capable of engagement with a trailer and adjustable along a Z-axis, each jack comprising:
an outer tube in a telescopic relationship with an inner tube; and
a drop leg in a telescopic relationship with said inner tube;
a connecting rod assembly located between said jacks and adjustable along an X-axis, wherein said connecting rod assembly comprises at least one adjustable section in a telescopic relationship with a central member;
at least one pivot adapter capable of pivoting said jacks in a Y-Z plane, wherein said adapter includes a first end engaged with an end of said connecting rod assembly and a second end engaged with one of said jacks.

2. The jack assembly of claim 1 further comprising a jack base secured to said drop leg.

3. The jack assembly of claim 1 further comprising at least one motor engageable with said outer tube and said inner tube.

4. The jack assembly of claim 1, wherein said connecting rod assembly includes a pair of adjustable sections located on each side of said central member.

5. The jack assembly of claim 4 further comprising a pair of pivot adapters.

6. The jack assembly of claim 5, wherein said pair of pivot adapters are located between one of said pair of jacks and one of said pair of adjustable sections.

7. The jack assembly of claim 4, wherein said adjustable sections and said central member include apertures capable of being aligned with each other.

8. The jack assembly of claim 1, wherein said jack is rotatable via said pivot adapter about the Y-Z plane into a storage position.

9. The jack assembly of claim 8, wherein said adapter includes at least one aperture for receiving a pin.

10. The jack assembly of claim 9, wherein said pin prevents said jack from rotation about the Y-Z plane.

11. A jack assembly for raising or lowering a trailer, said jack assembly comprising:
a pair of jacks vertically adjustable along a Z-axis capable of engagement with a trailer, each jack comprising:
an outer tube in a telescopic relationship with an inner tube; and
a drop leg in a telescopic relationship with said inner tube;
a connecting rod assembly horizontally adjustable along an X-axis located between said jacks comprising a pair of adjustable sections in a telescopic relationship with a central member;
at least one pivot adapter capable of pivoting said jacks in a Y-Z plane comprising:
at least one aperture;
a first end engaged with an end of said connecting rod assembly;
a second end engaged with one of said jacks; and
a pin assembly engaged with said at least one aperture of said at least one pivot adapter capable of preventing rotation of one of said jacks about a horizontal axis.

12. The jack assembly of claim 11, wherein said central member includes a plurality of apertures.

13. The jack assembly of claim 12, wherein said adjustable sections include a plurality of apertures alignable with said apertures of said central member.

14. The jack assembly of claim 13, wherein said central member is positionable to any apertures of said adjustable sections to adjust the length of the connecting rod assembly.

15. The jack assembly of claim 14, wherein said connecting rod assembly is adjustable to increase the distance between said jacks to adapt to a trailer having a wide wheelbase.

16. The jack assembly of claim 14, wherein said connecting rod assembly is adjustable to decrease the distance between said jacks to adapt to a trailer having a narrow wheelbase.
